(19) United States
(12) Patent Application Publication
(10) Pub. No.: US 2007/0125602 A1
(43) Pub. Date: Jun. 7, 2007

(54) Ladder, in particular swimming-pool ladder

(76) Inventor: Gerard Marbach, Cernay (FR)

Correspondence Address: JOHN S. PRATT, ESQ;KILPATRICK STOCKTON, LLP, 1100 PEACHTREE STREET, ATLANTA, GA, 30309, US

(21) Appl. No.: 10/094,293

(22) Filed: Mar. 8, 2002

(30) Foreign Application Priority Data
Mar. 9, 2001 (FR) 01 03244

(51) Int. Cl. E06C 7/00

(52) U.S. Cl. 182/228.1

(57) ABSTRACT

Ladder, in particular for a swimming pool, comprising two uprights (1) and at least one rung (2) fastened to the uprights, the rung (2) comprising, at its ends, a tubular sleeve (3) coaxially surrounding the corresponding upright (1), and a tubular locking insert ring (4) being engaged between the upright (1) and the sleeve (3) in order to lock the rung (2) axially on the upright (1); the insert ring (4) possesses, at each rung end (2), an outer cross section decreasing continuously from the bottom upwards and has a longitudinal slot (5) on at least most of its height; the tubular sleeve (3) has an inner shape complementary to the outer shape of the ring (4), with an inner cross section decreasing continuously from the bottom upwards; a longitudinal groove (15)/key (16) assembly fixes the sleeve and the insert ring together in terms of rotation in order to stabilize the ladder.

### FIELD OF THE INVENTION

The present invention relates to the general field of ladders and, in particular, although not exclusively, of swimming-pool ladders, and, more specifically, it relates to the fastening of the rungs to the uprights of the ladder, such a ladder comprising two uprights and at least one rung fastened to said uprights, said rung comprising, at its ends, a tubular sleeve coaxially surrounding the corresponding upright, and a tubular locking insert ring being engaged between the upright and the sleeve of the rung in order to lock the rung axially on the upright, the insert ring possessing, at each rung end, an outer cross section decreasing continuously from the bottom upwards and having at least one longitudinal slot over at least most of its height, and the tubular sleeve having an inner shape complementary to the outer shape of the insert ring, with an inner cross section decreasing continuously from the bottom upwards.

### DESCRIPTION OF THE PRIOR ART

Many embodiments of ladders and, in particular, many types of fastening of the rungs to the uprights are known, these fastenings being either definitive (for example, crimping or welding) or demountable, for example by screwing. The definitive fastenings have the advantage of being more resistant in mechanical terms, but the completed ladder is bulky (storage and transport difficulties). The demountable fastenings have the advantage, in particular, of making transport easier (delivery in demounted form in a packing case of small overall size, assembly by the user). However, screw-type fastenings have the disadvantage of a risk of oxidation at the drillholes for the passage of the screws, above all if the ladder is used in wet surroundings (swimming-pool ladders).

A demountable ladder is also known which comprises two uprights and at least one rung fastened to said uprights, each rung comprising, at its ends, a tubular sleeve coaxially surrounding the corresponding upright, and a tubular locking insert ring being engaged between the upright and the sleeve of the rung in order to lock the rung axially on the upright. Such a ladder is known, for example, from the document EP-A-0 644 314. However, this ladder has various disadvantages.

A first disadvantage is the arrangement for axially fixing together the upright and the insert ring: the upright is provided with a virtually annular cavity suitable for receiving a virtually annular complementary projection provided on the inner face of the insert ring produced in the form of a cylinder of revolution. Under these conditions, the axial retention of the ring on the upright is obtained only by virtue of the cooperation of the approximately radial bearing surfaces, one set back (edge of the cavity) on the upright and the other projecting (edge of the projection) on the ring. These bearing surfaces are narrow and of small area, and the forces which they have to withstand (weight of a person) are poorly distributed. This results in a fastening of low resistance.

Moreover, there is a risk of rotational displacement of the components in relation to one another, thus giving rise to an instability of the ladder (twisting) under a high load.

A second disadvantage is that it is necessary to carry out work to form the cavity on the metallic upright.

### SUMMARY OF THE INVENTION

The object of the invention is to provide an improved demountable-ladder arrangement which overcomes the abovementioned disadvantages of the known arrangements and which leads to a ladder which is easy to assemble and is resistant and stable.

To achieve this, a ladder, as mentioned in the introduction, is characterized, being arranged according to the invention, in that the inner cooperating face of the sleeve of the rung end and the outer cooperating face of the insert ring possess means for mutual locking in rotation, comprising an assembly formed from a longitudinal groove and from a longitudinal projecting key which have complementary shapes. By virtue of this arrangement, twisting of the ladder under the action of a high load is reliably avoided, and the solution is technically simple, easy to manufacture and efficient.

In an embodiment which is preferred in practice, the uprights are substantially in the form of a cylinder of revolution, the insert rings are of substantially frustoconical outer shape with a narrowing directed upwards, and the tubular sleeves of the rung ends are internally substantially frustoconical with a narrowing directed upwards, the insert rings then being capable of comprising a single longitudinal slot.

By virtue of these arrangements, an assembly operation of the conical-interlocking type is achieved, which concomitantly causes a firm clamping of the insert ring on the upright: the whole of the areas of the contact surfaces then cooperate and participate in the axial retention of the end of the rung on the corresponding upright. This results in an axial fixing together which is efficient and is more resistant in mechanical terms, whilst the assembling of the components remains very simple and does not require a specific tool: under these conditions, the ladder can be delivered, demounted, in the form of a packing case of small overall size, and it can be assembled without difficulty by an untrained user.

To ensure that the user assembling the ladder positions the rungs at the correct locations and, above all, positions the two ends of a rung in an identical axial position on the two respective uprights, it is advantageous that the inner cooperating face of the insert ring and the outer cooperating face of the associated upright possess means for the axial positioning of the ring on the upright; in a technically simple, but efficient solution, the positioning means comprise an assembly formed from a boss and a cup which have complementary shapes. It will be stressed, here, that the boss (provided, for example, on the insert ring produced from plastic) and the cup (produced, for example, by die stamping on the upright which is metallic) do not participate in axially fixing the ring together with the upright, but are merely positioning references: they therefore do not have to be mechanically resistant and they can be small in geometric terms.

Likewise advantageously, the insert ring may possess, at its base, an annular collar projecting radially outwards and suitable for serving as an axial stop for the corresponding tubular sleeve of the rung end.

The arrangements according to the invention are particularly easy to put into practice when the uprights are metallic, whilst the insert rings and the rungs are made of injected plastic.

The invention has a particularly useful application in swimming-pool ladders and, in particular, although not exclusively, in those swimming-pool ladders which have a general shape substantially in the form of an upturned V, for example for swimming pools above ground level, which are equipped with a double set of rungs (crossing over the wall of the swimming pool).

### BRIEF DESCRIPTION OF THE DRAWINGS

The invention will be understood more clearly from a reading of the following detailed description of some embodiments given purely by way of non-limiting example. In this description, reference is made to the accompanying drawings in which:

FIG. 1 is an exploded partial perspective view of the arrangement for fixing a rung end together with a ladder upright, within the scope of the invention;

FIG. 2 is a view in axial section of the arrangement of FIG. 1;

FIG. 3 is a cross-sectional view of the arrangement of FIGS. 1 and 2, illustrating the arrangements according to the invention;

FIG. 4 is a cross-sectional view of an alternative embodiment according to the invention of the arrangements shown in FIG. 3; and

FIG. 5 is a partial perspective view of a garden swimming pool equipped with a ladder arranged according to the invention.

### DETAILED DESCRIPTION OF THE INVENTION

The invention relates, as stated above, to a ladder comprising two uprights and at least one rung fastened to said uprights, in general a plurality of superposed rungs fastened to the uprights. FIGS. 1 to 3, to which reference will first be made, show:
a portion of one of the uprights 1, in tubular form, in particular metallic; in the example illustrated, this is a tubular upright in the form of a cylinder of revolution, this seeming to be the most frequent case in practice;
an end part of a rung 2 which may be of any shape and which comprises, at its end, a tubular sleeve 3 coaxially surrounding the upright 1; in the example illustrated, the rung 2 is assumed to be produced as a whole to virtually from injection-moulded plastic; and
a tubular locking insert ring 4 engaged between the upright 1 and the tubular sleeve 3 of the rung 2 in order to lock the rung 2 axially on the upright 1; the ring 4 may itself advantageously consist of injection-moulded plastic.

The insert ring 4 possesses an inner shape complementary to the outer shape of the upright 1; in the illustrated example of an upright 1 in the form of a cylinder of revolution, the ring 4 is internally in the form of a cylinder of revolution.

The insert ring 4 possesses externally a cross section decreasing continuously from the bottom upwards. In the example illustrated, because of its inner shape in the form of a cylinder of revolution, the ring 4 has externally a frustoconical shape, the small diameter of which is located at the top (see FIG. 1).

Finally, the ring 4 has, over at least most of its height, at least one longitudinal slot 5 which is suitable for allowing elastic deformation for the clamping of the ring 4 on the upright 1. As regards the externally frustoconical ring illustrated in FIG. 1, a single longitudinal slot 5 is sufficient to obtain the desired effect; this slot 5 then extends over the entire height of the ring 4.

In turn, the tubular sleeve 3 terminating the rung 2 has an inner shape complementary to the outer shape of the ring 4, with an inner cross-section decreasing continuously from the bottom upwards. In the example illustrated in the figures, the end tubular sleeve 3 possesses a frustoconical inner shape complementary to the frustoconical outer shape of the ring 4. In the illustration of FIG. 1, the end tubular sleeve 3 possesses a wall of substantially constant thickness (thus making it easier to mould it during manufacture), so that it has an external general shape which is likewise frustoconical.

For assembly, the insert ring 4 is slipped onto the upright 1 and arranged at the axial location of the latter required for installing the rung. The end sleeve 3 of the rung 2 is then, in turn, slipped onto the tube from the top of the latter, until it caps the ring 4 on which it is interlocked by force. Under the action of this interlocking by force via cooperating conical surfaces, the ring 4 is clamped elastically on the upright 1 on which it is then retained by friction (conical interlocking). No specific tool is needed in order to carry out this assembly.

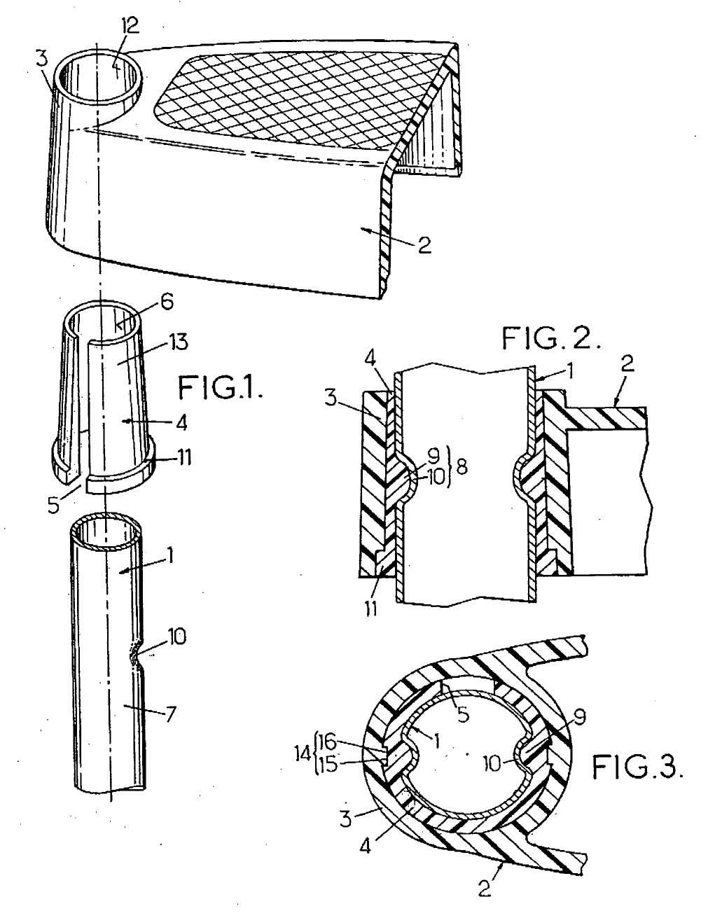

However, to allow for the inexperience of users carrying out the assembly of the ladder, it may be desirable to identify materially the location for positioning the rung or rungs, not only so that the rungs are spaced uniformly, but also, above all, so that the two ends of the same rung are axially positioned substantially identically on the two respective uprights. For this purpose, therefore, it is desirable that the inner cooperating face 6 of the insert ring 4 and the outer cooperating face 7 of the associated upright 1 possess means 8 for the axial positioning of the ring on the upright. These means can be produced in a simple way and, for example, comprise, as illustrated in FIGS. 1 to 3, an assembly formed from a boss 9, for example in the form of a spherical cap, which is preferably provided on the ring 4 (moulded integrally with the latter) and from a cup 10 which is preferably provided on the upright 1 (die-stamped on the latter), the boss 9 and the cup 10 having complementary shapes. As can be seen in FIGS. 2 and 3, two diametrically opposed assemblies 9, 10 may be provided.

An annular collar 11 projecting radially outwards may also be provided at the base of the insert ring 4. This collar constitutes a safety device and serves as an axial stop for the sleeve 3, so as to prevent the latter from sliding on the ring 4, should the rung 2 have to withstand an excessive load.

According to the invention,. the inner cooperating face 12 of the end sleeve 3 of the rung 2 and the outer cooperating face 13 of the insert ring 4 possess means 14 for mutual locking in rotation, in order to prevent a twisting of the ladder when it is put under load. As illustrated in FIG. 3, the means for mutual locking in rotation 14 comprise an assembly formed from a longitudinal groove 15 made in the outer face 13 of the ring 4 and from a longitudinal key 16 projecting on the inner face 12 of the sleeve 3, the groove 15 and the key 16 having complementary shapes and extending over the entire height of the ring 4 and of the sleeve 3, respectively. As illustrated in FIG. 3, two assemblies 15, 16 may be provided, which are diametrically opposed and may be located, for example, so as to correspond to the two assemblies 9, 10 mentioned above.

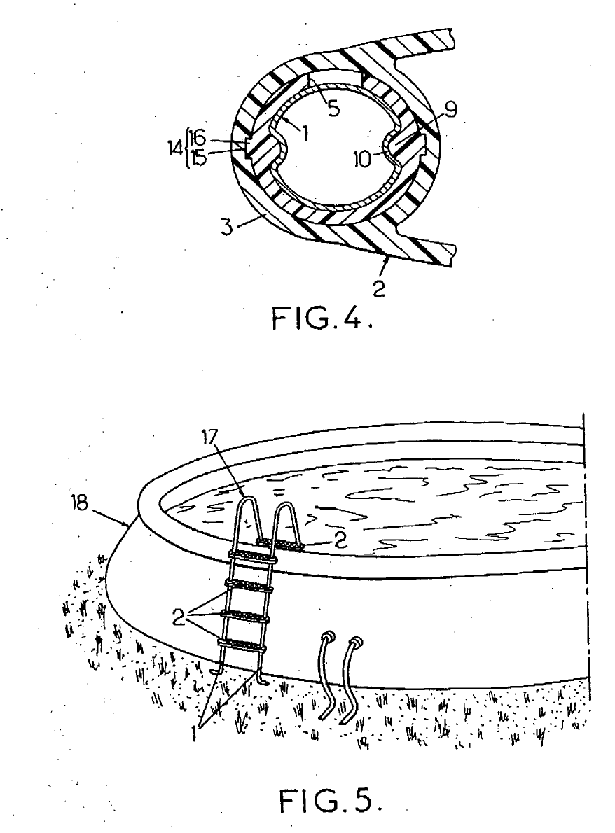

If the presence of the groove or grooves 15 leads to a weakening of the ring 4, the reverse arrangement illustrated in FIG. 4 may be adopted, with the groove 15 provided on the inner face 12 of the sleeve 1 and the projecting key 16 on the outer face of the ring 4.

Here, too, the grooves 15 and keys 16 are obtained directly by moulding during the manufacture of the ring 4 and of the rung 2 from injected plastic.

The arrangements which have just been described may be applied to all types of ladder, but they seem to have a particularly preferred application in swimming-pool ladders, particularly because of the ease of assembly which may suit a user who is a novice and also because of the absence of cooperating metallic parts which rules out any possibility of oxidation in wet surroundings.

The arrangements according to the invention are particularly suitable, as illustrated in FIG. 5, for a swimming-pool ladder 17 having a general shape substantially in the form of an upturned V, intended for equipping a swimming pool above ground level 18, such a double-slope ladder being equipped with two sets of rungs 2 arranged respectively outside and inside the swimming pool.

What is claimed is:

1. A ladder, comprising two uprights and at least one rung fastened to said uprights, said rung comprising, at its ends, a tubular sleeve coaxially surrounding the corresponding upright, and a tubular locking insert ring being engaged between the upright and the sleeve of the rung in order to lock the rung axially on the upright, the insert ring possessing, at each rung end. an outer cross section decreasing continuously from the bottom upwards and having at least one longitudinal slot over at least most of its height, and the tubular sleeve having an inner shape complementary to the outer shape of the insert ring, with an inner cross section decreasing continuously from the bottom upwards,
wherein the inner cooperating face of the sleeve of the rung end and the outer cooperating face of the insert ring possess means for mutual locking in rotation, comprising an assembly formed from a longitudinal groove and from a longitudinal projecting key which have complementary shapes.

2. A ladder according to claim 1, wherein said uprights are substantially in the form of a cylinder of revolution, wherein said insert rings are of substantially frustoconical outer shape with a narrowing directed upwards, and wherein said tubular sleeves of the rung ends are internally substantially frustoconical with a narrowing directed upwards.

3. A ladder according to claim 2, wherein each insert ring possesses a single longitudinal slot.

4. A ladder according to claim 1, wherein said inner cooperating face of the insert ring and the outer cooperating face of the associated upright possess means for the axial positioning of the ring on the upright.

5. A ladder according to claim 4, wherein said positioning means comprise an assembly formed from a boss and from a cup which have complementary shapes.

6. A ladder according to claim 1, wherein each insert ring possesses, at its base, an annular collar projecting radially outwards and suitable for serving as an axial safety stop for the corresponding tubular sleeve of the rung end.

7. A swimming-pool ladder, constitued according to claim 1.

8. A double swimming-pool ladder of general shape substantially in the form of an upturned V, in particular for a swimming pool above ground level, equipped with a double set of rungs, one at least of said ladders comprising two uprights and at least one rung fastened to said uprights, said rung comprising, at its ends, a tubular sleeve coaxially surrounding the corresponding upright, and a tubular locking insert ring being engaged between the upright and the sleeve of the rung in order to lock the rung axially on the upright, the insert ring possessing, at each rung end, an outer cross section decreasing continuously from the bottom upwards and having at least one longitudinal slot over at least most of its height, and the tubular sleeve having an inner shape complementary to the outer shape of the insert ring, with an inner cross section decreasing continuously from the bottom upwards,
wherein the inner cooperating face of the sleeve of the rung end and the outer cooperating face of the insert ring possess means for mutual locking in rotation, comprising an assembly formed from a longitudinal groove and from a longitudinal projecting key which have complementary shapes.

9. A double swimming-pool ladder according to claim 8, wherein said uprights are substantially in the form of a cylinder of revolution, wherein said insert rings are of substantially frustoconical outer shape with a narrowing directed upwards, and wherein said tubular sleeves of the rung ends are internally substantially frustoconical with a narrowing directed upwards.

10. A double swimming-pool ladder according to claim 9, wherein each insert ring possesses a single longitudinal slot.

11. A double swimming-pool ladder according to claim 8, wherein said inner cooperating face of the insert ring and the outer cooperating face of the associated upright possess means for the axial positioning of the ring on the upright.

12. A double swimming-pool ladder according to claim 11, wherein said positioning means comprise an assembly formed from a boss and from a cup which have complementary shapes.

13. A double swimming-pool ladder according to claim 8, wherein each insert ring possesses, at its base, an annular collar projecting radially outwards and suitable for serving as an axial safety stop for the corresponding tubular sleeve of the rung end.
